(19) United States
(12) Patent Application Publication
(10) Pub. No.: US 2010/0113016 A1
(43) Pub. Date: May 6, 2010

(54) Methods for routing a call to a mobile unit that has been ported

(76) Inventors: Ruth Schaefer Gayde, Naperville, IL (US); Donna Michaels Sand, Redmond, WA (US); Robin Jeffrey Thompson, Batavia, IL (US)

Correspondence Address: Alcatel-Lucent;Docket Administrator, Room 2F-192, 600-700 Mountain Ave., Murray Hill, NJ, 07974-0636, US

(21) Appl. No.: 12/290,536

(22) Filed: Oct. 31, 2008

(51) Int. Cl. H04W 4/00; H04W 40/00

(52) U.S. Cl. 455/433; 455/445

(57) ABSTRACT

The present invention provides a method for determining the HLR for a user who has been ported in to an IMS network. A call request is received for a mobile unit that has been ported. The communication system determines a Home Location Register (HLR) for the mobile unit. The communication system receives a temporary directory number associated with the mobile unit. The call request is completed to the mobile unit using the temporary directory number.

### FIELD OF THE INVENTION

The present invention relates generally to communication systems, and more particularly to routing calls to a mobile user.

### BACKGROUND OF THE INVENTION

Voice Call Continuity (VCC) provides for convergence of services provided by an Internet Protocol (IP) Multimedia Subsystem (IMS) and a mobile network for user devices that can connect to both types of networks. A component of the VCC service is the call delivery application server (CD AS) which delivers incoming calls to the appropriate network based on the current location of the user device and service provider and subscriber policy. This may include a query to the Home Location Register (HLR) in the user's mobile network to obtain the routing number used to route the call to the current serving MSC within the mobile network.

Users can “port” their number to a different service provider network. Porting refers to changing service providers while retaining their mobile directory number, thus allowing callers to reach them at the new network via the same number. When porting from one cellular service provider to another, the user is provisioned on a different HLR in the new service provider's network.

As a result of this porting capability, it is no longer possible to map a range of mobile directory numbers (DNs) to a specific HLR. This is due to directory numbers in the number range that used to belong to a specific HLR being ported to other HLRs and numbers that used to map to other HLRs being ported into this HLR.

Sometimes this number porting mechanism is used to port the subscriber's “home” network from a cellular network to an IMS network. This can happen in dual mode IMS and cellular service offerings. In this architecture, each subscriber still requires an HLR entry in the cellular network to support cellular service. Because the IMS may be a very large system supporting subscribers on many different HLRs, the CD AS must be able to direct routing queries to many HLRs. The number portability infrastructure can be used to port the subscriber to the IMS network, but the IMS network may not have the HLR for that subscriber. In some networks, the HSS may contain both the IMS subscriber data and the HLR subscriber data, though this is not required. The Location Routing Number (LRN) may not be relied upon to determine a particular HLR destination, because while the LRN identifies a particular IMS gateway, the IMS gateway does not have a direct relationship to any particular HLR. Furthermore, the LRN information may not even be delivered to the CD AS, which needs to make the location query to the HLR.

Therefore, a need exists for a way to determine the HLR for a mobile unit that has ported its directory number to the IMS system, so that the mobile unit can also be reached via the cellular network.

### BRIEF SUMMARY OF THE INVENTION

The present invention relates generally to a method for routing a call to a mobile unit that has been ported. In a first exemplary embodiment, a location routing number (LRN) to Home Location Register (HLR) mapping is done in a call delivery application server. After number porting, calls to the mobile unit can be routed to the new service provider using the Number Portability Database (NPDB) which maintains an association between the subscriber's DN and the Location Routing Number (LRN). Calls to a ported mobile unit cause a query to the NPDB and the resulting LRN is used to route the call to the new MSC for the ported user. If for a given service provider the LRN is assigned to the ported-in subscribers such that all ported-in subscribers with that LRN are in the same HLR then the LRN used to route the call to the IMS can be used as the key to map to the HLR for each user. This is advantageous in the case where the IMS, which may be geographically dispersed across many rate centers, is providing services for ported-in users on many HLRs which may be in different service provider networks.

In a second exemplary embodiment, a subscriber to HLR mapping is accomplished in an HSS. This solution does not depend on the call delivery application server receiving the LRN. In this exemplary embodiment, the HSS entry for each mobile unit includes the HLR identifier or destination point code in the subscriber data for each user ported into the IMS. As each call is routed to the IMS and to the call delivery application server, the call delivery application server queries the HSS for the HLR ID or destination point code (DPC) and uses that information to route the location request message to the correct HLR. Alternatively, the call delivery application server may query the HSS for this information prior to the call and store the information in local memory.

In a third exemplary embodiment, an HSS is queried for the IMSI of the called mobile unit. In this exemplary embodiment, the HSS is queried, but the query returns the mobile user's IMSI (International Mobile Station Identifier) or other mobile user identifier such as Mobile Identification Number (MIN) which is existing subscriber data in the HSS, thus avoiding the need to provision additional data in the form of the HLR identifier for each subscriber. Unlike the directory number which is unchanged when the user ports their number to a new service provider, the IMSI (or MIN) is modified when porting occurs and a contiguous range of IMSI (or MIN) are assigned to each HLR. An advantage of this solution is that in many cases the IMSI is existing data for each user in the HSS and the IMSI to HLR mapping is existing in the CD AS or network STPs.

### BRIEF DESCRIPTION OF THE SEVERAL VIEWS OF THE DRAWINGS

FIG. 1 depicts an IMS and circuit roaming system in accordance with an exemplary embodiment of the present invention, utilizing a location routing number.

FIG. 2 depicts a call flow of a method for routing a call to a mobile unit utilizing a location routing number.

FIG. 3 depicts a call flow of a method for routing a call to a mobile unit.

### DETAILED DESCRIPTION OF THE INVENTION

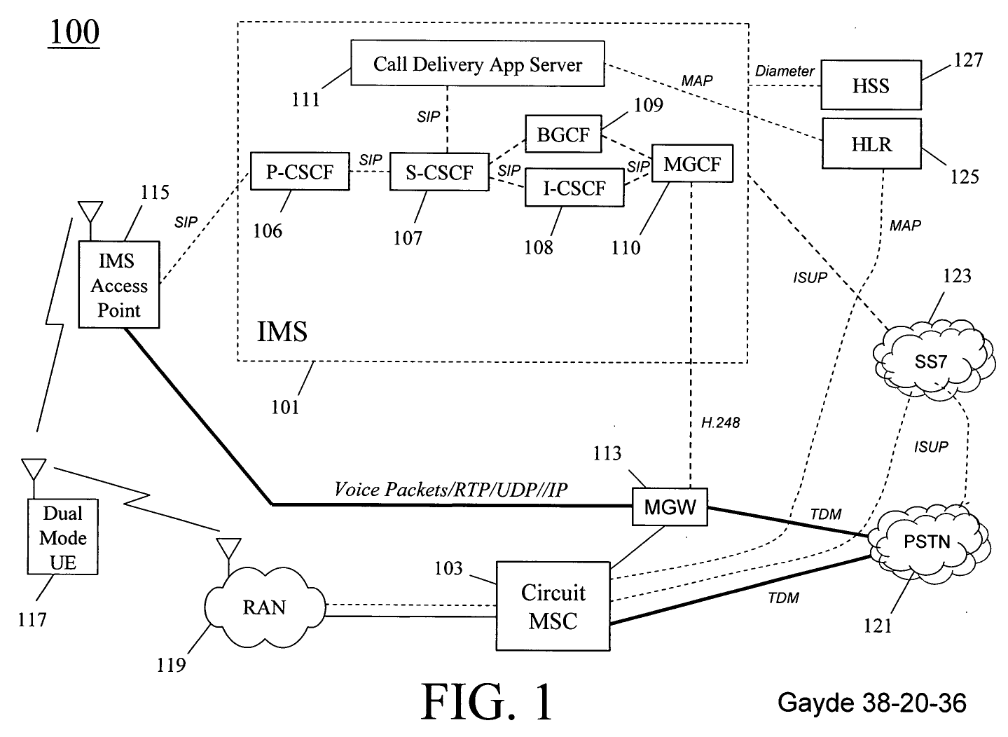

The present invention can be better understood with reference to FIGS. 1-3. FIG. 1 depicts an IMS and circuit roaming system 100 in accordance with an exemplary embodiment of the present invention. System 100 includes IMS (IP Multimedia Subsystem) 101, circuit MSC (Mobile Switching Center) 103, IMS Access Point 115, RAN (Radio Access Network) 119, PSTN (Public Switched Telephone Network) 121, SS7 (Signaling System 7) 123, HLR (Home Location Register) 125, and HSS (Home Subscriber Server) 127. In some embodiments, the HSS and HLR may be on the same physical device.

IMS 101 is responsible for call and session control provided by the IMS in the subscriber's home network. IMS Server 101 manages SIP sessions, provides features and services, coordinates with other network elements for session control, and allocates media resources.

IMS Server 101 includes a plurality of functions and components, which may be installed on separate servers or can alternately share the same server. This allows for flexible packaging for various customer needs. IMS 101 comprises P-CSCF (Proxy Call Session Control Function) 106, S-CSCF (Serving CSCF) 107, I-CSCF (Interrogating CSCF) 108, BGCF (Breakout Gateway Control Function) 109, MGCF (Media Gateway Control Function) 110, and Call Delivery Application Server 111. IMS Server 101 is connected to MGW (Media Gateway) 113.

P-CSCF 106 is preferably the first contact for a SIP mobile unit to gain access to IMS 101 from the access packet network domain. P-CSCF 106 provides the necessary SIP routing capability between SIP mobiles and IMS 101. P-CSCF 106 also coordinates with the access network to authorize the resources and Quality-of-Service (QoS). For services that are offered by the home IMS network, P-CSCF 106 relays the SIP signaling to the IMS server in the home network.

S-CSCF 107 manages SIP sessions and coordinates with other network elements for call/session control. S-CSCF 107 performs SIP registration, session control, service control, call monitoring, and security. SIP registration comprises processing SIP REGISTER requests and maintaining subscriber data and state information for the duration of the registration session. Session control comprises performing call/session setup, modification, and termination. Service control comprises interaction with Application Services platforms for the support of features and services. Call monitoring comprises call monitoring and recording for accounting and other related services. Security comprises providing security for the session.

SIP user clients communicate to the various application servers via S-CSCF 107. S-CSCF 107 provides the messaging filtering, message forwarding, and transaction and session control functions for the sessions initiated by SIP signaling. S-CSCF 107 also allows the various SIP-based application servers to communicate with each other. S-CSCF 107 also preferably provides SIP proxy functions for forwarding SIP messages to the proper application server and allowing application servers to subscribe to SIP dialogs between SIP clients and servers.

Because S-CSCF 107 supports standard SIP messages, the user clients and SIP application servers can span a wide variety of telephony and non-telephony services. For example, S-CSCF 107 can provide the message filtering and forwarding for SIP-based services such as Instant Messaging (IM), Push-To-Talk, Voice Call Continuity (VCC), and multimedia services.

I-CSCF 108 is the contact point within system 100 for all connections destined to a subscriber connected to system 100 or a roaming subscriber currently located within the service areas supported by system 100. System 100 may include multiple I-CSCFs. I-CSCF 108 retrieves an S-CSCF assignment for each user performing SIP registration. I-CSCF 108 also obtains from HSS 127 the address of S-CSCF 107 and uses the address to route a SIP request or response received from a network towards S-CSCF 107.

In accordance with an exemplary embodiment of the present invention, the functions of I-CSCF 108 are hidden from outside systems. Examples of functions that can be hidden include, but are not limited to, the configuration, capacity, and topology of the IMS 101. When the functions of I-CSCF 108 are being hidden, I-CSCF 108 forwards SIP requests and responses to an I-CSCF on another network for sessions traversing multiple networks. This allows network operators to maintain configuration independence.

BGCF 109 selects the network in which PSTN breakout is to occur. If BGCF 109 determines that the breakout is to occur in the same network where BGCF 109 is located, BGCF 109 selects a Media Gateway Control Function (MGCF). The MGCF is responsible for the interworking with the PSTN network. If the breakout is in a different network, BGCF 109 forwards this session signaling to a BGCF, or an MGCF, depending on configuration, in the different network.

MGCF 110 provides the signaling inter-working functions between IMS 101 and PSTN 121. MGCF 110 controls a set of media gateways, such as MGW 113, utilizing H.248 signaling. The use of H.248 signaling allows MGCF 110 to control establishment of bearer resources for sessions that require inter-working for bearer traffic between the PSTN 121 and IMS 101.

Call Delivery Application Server 111 is an application server that provides the call delivery function for communication system 100. In an exemplary embodiment, there may be multiple application servers. Call Delivery Application Server 111 preferably provides service logic as part of a call or session between two user endpoints.

The CSCF uses filter criteria to include Call Delivery Application Server 111 for service logic as directed by the per-subscriber data from HSS 127.

S-CSCF 107 uses filter criteria to involve Call Delivery Application Server 111 for call delivery determination and as needed to provide features and services. Filtering is done in S-CSCF 107 on SIP request messages only, such as INVITE, REGISTER, SUBSCRIBE, BYE, but not on responses to requests. Filtering can be based on such things as the method of the SIP request, on whether the request was received in the originating or terminating case, on whether a particular media type is included in the SDP of a request, or on the presence or content of a particular SIP header.

A specific user may get services from more than one Application Server. A Filter Criteria applies to one specific Application Server and the service profile of a user contains a set of Filter Criteria. During registration of a user, S-CSCF 107 obtains the set of initial Filter Criteria from HSS 127 that gives information about the Application Server(s) that need to be involved for the user, under which circumstances each gets involved, and the priorities of the Filter Criteria. At the time of registration, S-CSCF 107 sends a third-party REGISTER request to each Application Server whose Filter Criteria have a match for the REGISTER event. An Application Server can then get additional Application Server-specific data from HSS 127, if needed.

When S-CSCF 107 receives from the user a SIP request for a dialog, it evaluates the highest priority initial Filter Criteria. If the SIP request matches the filter criteria, S-CSCF 107 proxies the SIP request to the corresponding Application Server. The Application Server performs service logic, may modify the SIP request, and may send the request back to S-CSCF 107. The output of the first Application Server, if it satisfies the initial filter criteria for the second Application Server, is the input of the second Application Server, and so on. The sequence order of the Application Server(s) is based on the relative priorities of their respective initial Filter Criteria obtained from HSS 127 at registration time.

The service logic performed by Call Delivery Application Server 111 may result in a negative response to the SIP request. In this case, S-CSCF 107 will not evaluate any lower priority initial Filter Criteria and their corresponding Application Server(s) providing other services will not be reached.

Call Delivery Application Server 111 implements at least those capabilities of a Gateway MSC in a legacy cellular network that are needed to perform call delivery to Dual Mode UE 117 when the Dual Mode UE 117 is registered at an HLR 125 within a circuit-mode cellular network. In a first exemplary embodiment, Call Delivery Application Server 111 has a MAP interface to HLR 125 and appears to HLR 125 as if it were a standard Gateway MSC within the legacy cellular network by performing standard MAP call delivery. In a second exemplary embodiment, Call Delivery Application Server 111 has an ANSI-41 interface to HLR 125 and appears to HLR 125 as if it were a standard Gateway MSC within the legacy cellular network by performing ANSI-41 call delivery procedures. Call Delivery Application Server 111 may also query HLR 125 to retrieve HLR-based terminating feature information for different flavors of call forwarding, call barring, terminating triggers, etc. Call Delivery Application Server 111 may provide these features to Dual Mode UE 117.

Since Call Delivery Application Server 111 is an Application Server, it can also receive third-party registration information from S-CSCF 107, which details the registration status of Dual Mode UE 117 within IMS 101. When receiving a new call termination for the subscriber according to standard IMS call delivery procedures, Call Delivery Application Server 111 may use information about the registration status of Dual Mode UE 117 within IMS 101 and the circuit-mode cellular network to determine whether to deliver the call to Dual Mode UE 117 via P-CSCF 106 and packet access network, e.g., the IMS Access Point 115, or via the circuit-mode cellular network, e.g., Circuit MSC 103 and RAN 119. If Dual Mode UE 117 is registered in both networks, Call Delivery Application Server 111 may choose to attempt delivery via either one network or both, and in any sequence and timing, including simultaneously.

Media Gateway (MGW) 113 provides bearer traffic connectivity to PSTN 121, preferably via asynchronous, synchronous and optical terminations. MGW 113 is also able to communicate with other Public Land Mobile Networks (PLMNs). MGW 113 also provides echo cancellation and some tone generation. MGW 113 preferably is controlled from MGCF 110 using the H.248 standard over an IP switching fabric.

MGW 113 preferably includes digital signal processors (DSPs) that provide a path between the IP multimedia domain and the circuit switched environment, including PSTN 121, for bearer traffic. MGW 113 supports media conversion, bearer control, and payload processing. The DSPs preferably support G.711 (A & μ law), G.723.1 at either 6.3 Kbps or 5.3 Kbps and G.729 at 8 Kbps, EVRC, AMR and 4 GV. The DSPs also provide E.168 echo cancellation and silence suppression with comfort noise generation in MGW 113.

Circuit MSC 103 connects landline PSTN system 121 to the mobile phone system. Circuit MSC 103 is also responsible for compiling call information for accounting and handing off calls from one cell to another.

IMS Access Point 115 is an access dependent device that permits access to IMS 101. Access points are typically stand-alone devices that plug into an Ethernet hub or switch. Access points cover a certain range, perhaps as much as a thousand feet, and mobile users are automatically handed off from one to the other as they walk to other offices or locations. IMS Access Point 115 can be, but is not limited to, a WiFi Network, a WiMAX network, an HRPD network, an HSPD network, an HSDPA network, or a Femtocell.

RAN 119 is the radio access network providing circuit-mode access to the PSTN via Circuit MSC 103 for Dual Mode UE 117 when registered with the circuit-mode cellular network at HLR 125.

PSTN 121 is the current narrowband-based telephone network that was designed for voice traffic.

SS7 123 is an out-of-band signaling network that carries call control and transaction messages for the PSTN, ISDN, Intelligent Network, and PLMN.

HLR 125 is a database in communication system 100 that includes all the home subscribers within the service area of the circuit-mode cellular network served by Circuit MSC 103 and RAN 119. When a subscriber reaches a new service area in the circuit-mode cellular network, the data in HLR 125 is requested and transferred via SS7 123 to a VLR (Visitor Location Register) associated with a Circuit MSC 103 in the new area.

HSS 127 is the master subscriber database for IMS 101 and includes registration status and subscription data for users. The data within HSS 127 is used by the different network core functional entities in IMS 101 when processing subscribers. HSS 127 includes user data that can be downloaded to S-CSCF 107. HSS 127 stores temporary data with the location of S-CSCF 107 where the user is currently registered. HSS 127 and HLR 125 may be co-located.

Dual Mode UE 117 is a subscriber device that is preferably capable of operating in either or both of two modes. One mode provides for registration and access to an IMS network via IMS Access Point 115. The second mode provides for registration and access to a circuit-mode cellular network via RAN 119 and Circuit MSC 103. The selection of the operating mode(s) for the device depends on the availability of service from the networks and the capabilities of the device.

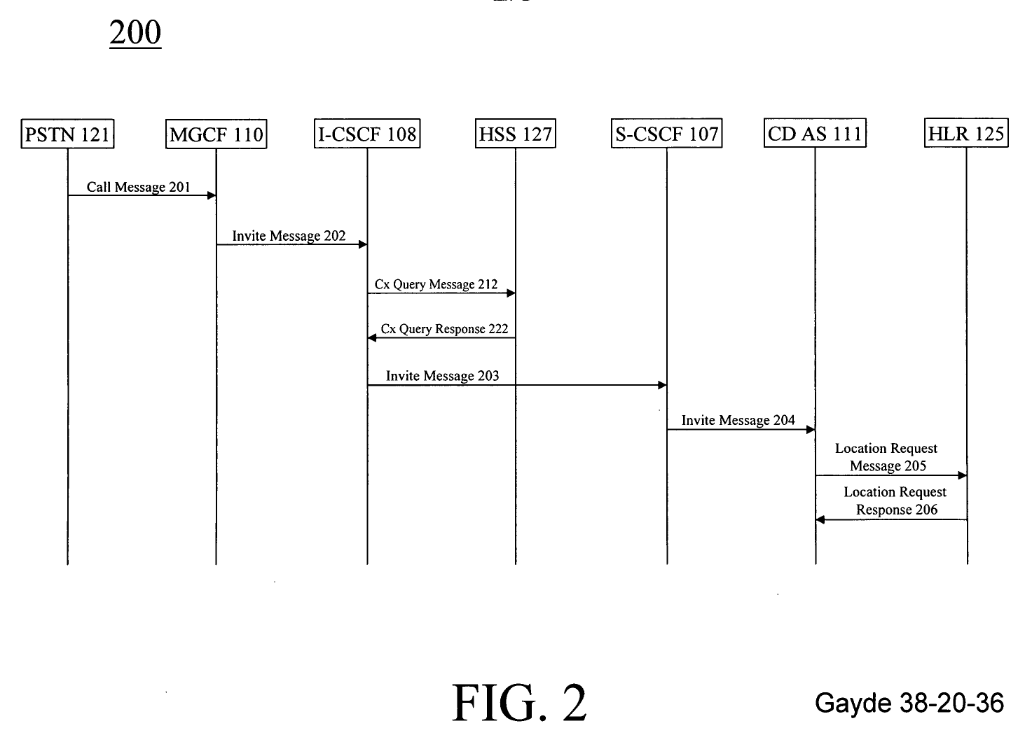

FIG. 2 depicts a call flow 200 that depicts a call coming in to a VoIP user. In the exemplary embodiment depicted in FIG. 2, PSTN 121 queries a number portability database to retrieve the location routing number (LRN) for the system serving the called mobile unit. In this exemplary embodiment, call delivery application server 111 maps the LRN to an HLR.

PSTN 121 routes call message 201 to MGCF 110 of IMS 101. Message 201 is preferably an ISUP IAM message that includes the location routing number of the called mobile unit, the directory number of the called mobile unit, and an indication that the directory number has been queried for its number portability status and relevant LRN. In this exemplary embodiment, IMS 101 is the system the called user has ported to and calls are routed to using the retrieved LRN from the queried number portability database. In an alternate exemplary embodiment, message 201 is a SIP INVITE message or similar message.

MGCF 110 performs standard translation of the incoming ISUP IAM parameters to the SIP INVITE headers to create invite message 202. This preferably includes populating the Request URI with the called party's number, the routing number set to the retrieved LRN and an indication that a ported number database query has been performed. MGCF 110 routes invite message 202 to I-CSCF 108.

I-CSCF 108 queries HSS 127 via Cx Query message 212 to determine where to route the information from invite message 202.

HSS 127 returns Cx Query Response 222 to I-CSCF 108. Cx Query Response 222 preferably provides the S-CSCF that is handling this call request.

I-CSCF 108 sends Invite Message 203 to S-CSCF 107. Invite Message 203 preferably includes populating the Request URI with the called party's number, the routing number set to the retrieved LRN and an indication that a ported number database query has been performed.

S-CSCF 107 determines that Invite Message 203 should be routed to Call Delivery Application Server 111. In an exemplary embodiment, S-CSCF 107 determines utilizing initial filter criteria where Invite Message 203 should be routed.

S-CSCF 107 sends invite message 204 to CD AS 111. Invite message 204 preferably includes populating the Request URI with the called party's number, the routing number set to the retrieved LRN and an indication that a ported number database query has been performed.

CD AS 111 determines that delivery of this call requires a message be sent to HLR 125. In an exemplary embodiment, the message to be sent to HLR 125 is a LocationRequest (LOCREQ) message. In a second exemplary embodiment, the message sent to HLR 125 is a SendRoutingInformation message sent from CD AS 111 to a GSM/UMTS HLR. CD AS 111 preferably determines the destination point code for the HLR associated with the called party by using the LRN as a key in an LRN/HLR DPC mapping table.

CD AS 111 routes location request message 205 to HLR 125.

HLR 125 returns the routing number to CD AS 111 in location request response 206. At this point, the call delivery to the Temporary Local Directory Number (TLDN) continues.

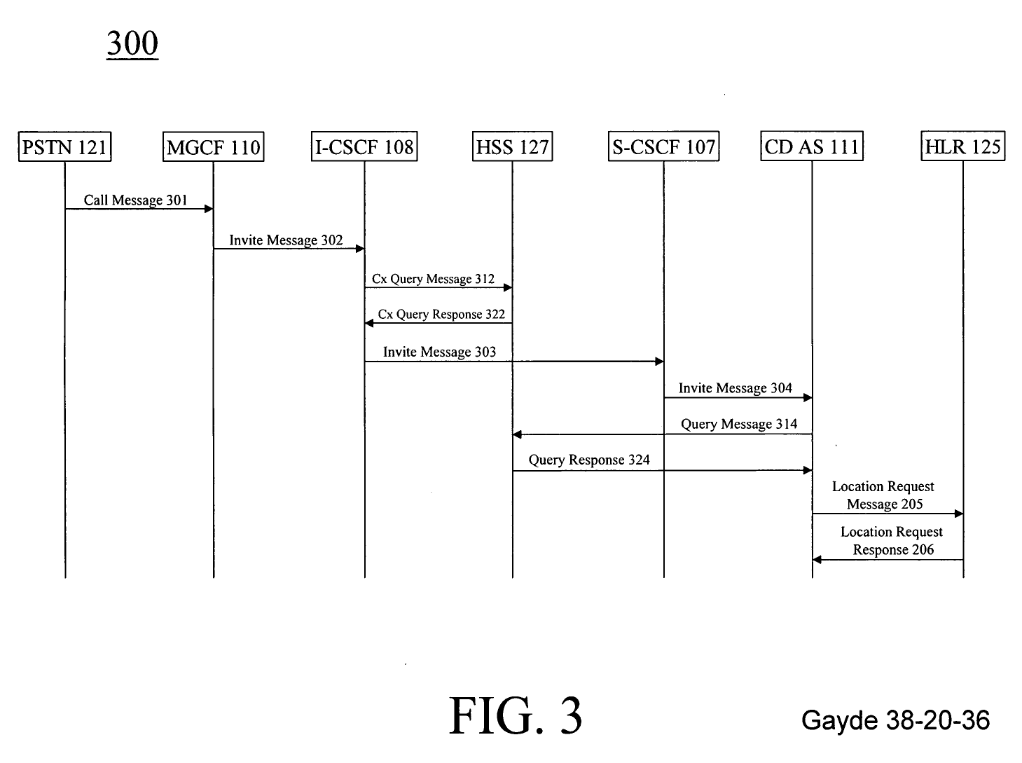

FIG. 3 depicts a call flow 300 that depicts a call coming in to a VoIP user. In the exemplary embodiment depicted in FIG. 3, PSTN 121 queries a number portability database to retrieve the location routing number (LRN) for the system serving the called mobile unit. In a first exemplary embodiment of this FIG., call delivery application server 111 queries an HSS associated with the user to determine the user's HLR. In a second exemplary embodiment, call delivery application server 111 utilizes the IMSI of the called mobile unit to determine the HLR, preferably by using translation tables in CD AS 111. Alternately, global title translation using the IMSI as the global title address can be employed by the SS7 STPs in the network.

PSTN 121 routes call message 301 to MGCF 110 of IMS 101. Message 301 is preferably an ISUP IAM message that includes the location routing number of the called mobile unit, the directory number of the called mobile unit, and an indication that the directory number has been queried for number portability status and relevant LRN. In this exemplary embodiment, IMS 101 is the system the called user has ported to using the retrieved LRN from the queried number portability database.

MGCF 110 performs standard translation of the incoming ISUP IAM parameters to the SIP INVITE headers to create invite message 302. This preferably includes populating the Request URI with the called party's number, the routing number set to the retrieved LRN and an indication that a ported number database query has been performed. MGCF 110 routes invite message 302 to I-CSCF 108.

I-CSCF 108 queries HSS 127 via Cx Query message 312 to determine where to route the information from invite message 302.

HSS 127 returns Cx Query Response 322 to I-CSCF 108. Cx Query Response 322 preferably provides the S-CSCF that is handling this call request.

I-CSCF 108 sends Invite Message 303 to S-CSCF 107. Invite Message 303 preferably includes populating the Request URI with the called party's number.

S-CSCF 107 determines that Invite Message 303 should be routed to Call Delivery Application Server 111. In an exemplary embodiment, S-CSCF 107 determines utilizing initial filter criteria where Invite Message 303 should be routed.

S-CSCF 107 sends invite message 304 to CD AS 111. Invite message 304 preferably includes populating the Request URI with the called party's number.

CD AS 111 determines that delivery of this call requires a message be sent to HLR 125. In an exemplary embodiment, the message to be sent to HLR 125 is a LocationRequest (LOCREQ) message. In this exemplary embodiment, the local database for HLR lookup is provisioned to point to a destination route database. The destination route database includes the HLRs destination point code or Global Title Translation for a particular route.

CD AS 111 sends query message 314 to HSS 127. CD AS 111 preferably sends query message 414 to HSS 127 via the Sh interface. HSS 127 preferably uses the Mobile Directory Number (MDN) as a key to retrieve the HLR DPC from a local data table. Alternately, HSS 127 uses the MDN as a key to retrieve the International Mobile Station Identifier (IMSI) from a local data table.

HSS 127 responds with query response 324. In a first exemplary embodiment, query response 324 includes the DPC address of the HLR that is servicing the mobile unit. In a second exemplary embodiment, query response 324 includes the IMSI (or MIN) of the mobile unit. CD AS 111 retrieves the HLR destination point code from a local IMSI range to HLR DPC mapping table. In accordance with an exemplary embodiment, CD AS 111 may keep a temporary local cache of HSS query results. This avoids an HSS query for every incoming call request.

CD AS 111 routes location request message 305 to HLR 125, preferably using the HLR DPC as the destination for the LOCREQ. Alternately, CD AS 111 routes the location request message 305 to the HLR via global title translation using the IMSI (or MIN) as the global title address can be employed by the SS7 STPs in the network.

HLR 125 returns the routing number to CD AS 111 in location request response 306. At this point, the call delivery to the TLDN in ANSI-41 networks or the MSRN in GSM/UMTS networks continues.

While this invention has been described in terms of certain examples thereof, it is not intended that it be limited to the above description, but rather only to the extent set forth in the claims that follow.

We claim:

1. A method comprising:
receiving a call request for a mobile unit that has been ported;
determining a Home Location Register (HLR) for the mobile unit;
receiving a temporary directory number associated with the mobile unit; and
completing the call request to the mobile unit using the temporary directory number.

2. A method in accordance with claim 1, wherein the step of receiving a temporary directory number associated with the mobile unit comprises sending an invite message to a call delivery application server.

3. A method in accordance with claim 2, wherein the step of sending an invite message comprises an S-CSCF sending the invite message to the call delivery application server.

4. A method in accordance with claim 2, wherein the invite message comprises a Request URI with a directory number of the called mobile unit.

5. A method in accordance with claim 1, wherein the step of determining an HLR for the mobile unit comprises a call delivery application server determining that delivery of the call request requires a message be sent to the HLR.

6. A method in accordance with claim 5, wherein the message is a location request message.

7. A method in accordance with claim 5, wherein the message is a send routing information message.

8. A method in accordance with claim 7, wherein the send routing information message is sent to a GSM/UMTS HLR.

9. A method in accordance with claim 1, wherein the step of determining the HLR for the mobile unit comprises determining the HLR for the mobile unit using a location routing number.

10. A method in accordance with claim 9, further comprising the step of using the location routing number as a key in a mapping table.

11. A method in accordance with claim 9, further comprising the step of routing a location request message to the HLR.

12. A method in accordance with claim 1, wherein the step of receiving a temporary directory number associated with the mobile unit comprises returning a routing number from the HLR.

13. A method in accordance with claim 1, wherein the step of determining an HLR for the mobile unit comprises sending a query message to a Home Subscriber Server (HSS).

14. A method in accordance with claim 13, further comprising the step of using, at the HSS, a mobile directory number of the mobile unit as a key to retrieve the HLR identifier and address.

15. A method in accordance with claim 13, further comprising the step of retrieving an International Mobile Station Identifier (IMSI) from a local data table.

16. A method in accordance with claim 15, wherein the HSS uses a mobile directory number of the mobile unit as a key to retrieve the IMSI.

17. A method in accordance with claim 15, further comprising the step of retrieving an HLR destination point code from a local IMSI range to DPC mapping table.

18. A method in accordance with claim 15, further comprising the step of routing the call request to a network signaling transfer point.

19. A method in accordance with claim 13, wherein the HSS keeps a temporary local cache of query results at the HSS.

20. A method in accordance with claim 13, further comprising the step of retrieving a Mobile Identification Number (MIN) from a local data table.
